(19) United States
(12) Patent Application Publication
(10) Pub. No.: US 2006/0172192 A1
(43) Pub. Date: Aug. 3, 2006

(54) Battery

(76) Inventors: Fred J. Berkowitz, New Milford, CT (US); Jaroslav Janik, Southbury, CT (US); Stephen Benoit, Southbury, CT (US); Mark Brown, Brookfield, CT (US); Anthony Malgioglio, Stamford, CT (US)

Correspondence Address: FISH & RICHARDSON P.C., P.O. BOX 1022, MINNEAPOLIS, MN, 55440-1022, US

(21) Appl. No.: 11/050,247

(22) Filed: Feb. 3, 2005

(51) Int. Cl. H01M 2/08; H01M 2/04; H01M 10/04; H01M 2/12

(52) U.S. Cl. 429/185; 429/175; 29/623.4; 29/623.2; 429/56

(57) ABSTRACT

A battery has a housing, a cover, and a seal engaged with the cover. The cover has an outer edge and is connected to the housing at the outer edge. The cover includes at least one portion of reduced thickness between the outer edge of the cover and the seal.

### TECHNICAL FIELD

The invention relates to batteries.

### BACKGROUND

Batteries are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

A battery typically includes a housing and a seal assembly that contain the active materials, the electrolyte and the separator. In some embodiments, the seal assembly includes a cover and a conductor connected to the cover. The conductor may contact one of the active materials and serve as an electrical terminal of the battery. The cover can be connected to the housing by crimping or welding to provide a liquid-tight seal.

### SUMMARY

In one aspect of the invention, a battery has a housing, a cover, and a seal engaged with the cover. The cover has an outer edge and is connected to the housing at the outer edge. The cover includes at least one portion of reduced thickness between the outer edge of the cover and the seal.

The portion of reduced thickness can be a groove in the cover. The groove can have a triangular cross-section. In other embodiments, the groove has a semi-circular cross-section.

The portion of reduced thickness of the cover can be between about 5 and about 90 percent of a thickness of the cover. The portion of reduced thickness of the cover can be between about 10 and about 50 percent of a thickness of the cover.

The cover can have two portions of reduced thickness located on opposing sides of the seal. In some embodiments, a semicircular portion of reduced thickness extends around the seal to connect the two straight portions of reduced thickness. In some embodiments, the portion of reduced thickness encircles the seal entirely. In some embodiments, the portion of reduced thickness contacts the seal.

The battery may also have a conductor extending through the cover with the seal being between the conductor and an inner edge of the cover. The conductor may be a rivet. In some embodiments, the rivet defines an opening that extends through the rivet that can be used as a hole for filling the battery.

In another aspect, a battery has a housing, a cover, and a seal. The cover has an outer edge at which the cover is connected to the housing. The cover includes at least a portion of reduced thickness between the outer edge of the cover and the seal, the portion of reduced thickness comprising two grooves in the cover located on opposing sides of the seal. The seal is engaged with the cover.

In some embodiments, the grooves have triangular cross-sections. In other embodiments, the grooves have semi-circular cross-sections.

In another aspect, a method of manufacturing a battery includes placing an anode and a cathode into a housing and welding a cover to the housing. The cover has an outer edge, is sized to engage with the housing, and has a hole sized to receive a conductor. The cover also includes at least a portion of reduced cross-section between the outer edge of the cover and the hole.

Batteries can incorporate seals to electrically isolate a conductor, placed through the battery cover and into the battery housing, from the battery cover. Including portions of reduced thickness in the battery cover, between the outer edge of a battery cover and the seal around the conductor, may limit heat transfer from the outer edge to the seal. Allowing higher temperature welding processes to be used without damaging heat-sensitive seals can enable faster, more efficient manufacturing processes as well as providing better attachment between the battery housing and the cover. This may be particularly useful in the manufacture of prismatic batteries whose flat sides make it difficult to get a good weld between the battery housing and the cover without damaging the seal due to the seal's proximity to the outer edge of the cover. In addition, by limiting heat transfer from the outer edge of the cover to the seal, including these portions of reduced thickness in the battery cover enables the use of inexpensive plastics as a material to form the conductor seal. As a result, batteries can be made less expensively and have fewer heat-induced failures caused by welding during the manufacturing process.

The details of one or more embodiments of the invention are set forth in the accompanying drawings and the description below. Other aspects, features, and advantages of the invention will be apparent from the description and drawings, and from the claims.

### DESCRIPTION OF DRAWINGS

FIG. 1 is a perspective view of an embodiment of a battery.

FIG. 2A is a perspective view of an embodiment of a seal assembly; FIG. 2B is a top view of the seal assembly of FIG. 2A; and FIG. 2C is a cross-sectional view of the seal assembly of FIG. 2A, taken along line 2C-2C.

FIG. 3 is a top view of an embodiment of a seal assembly.

FIG. 4 is a top view of an embodiment of a seal assembly.

### DETAILED DESCRIPTION

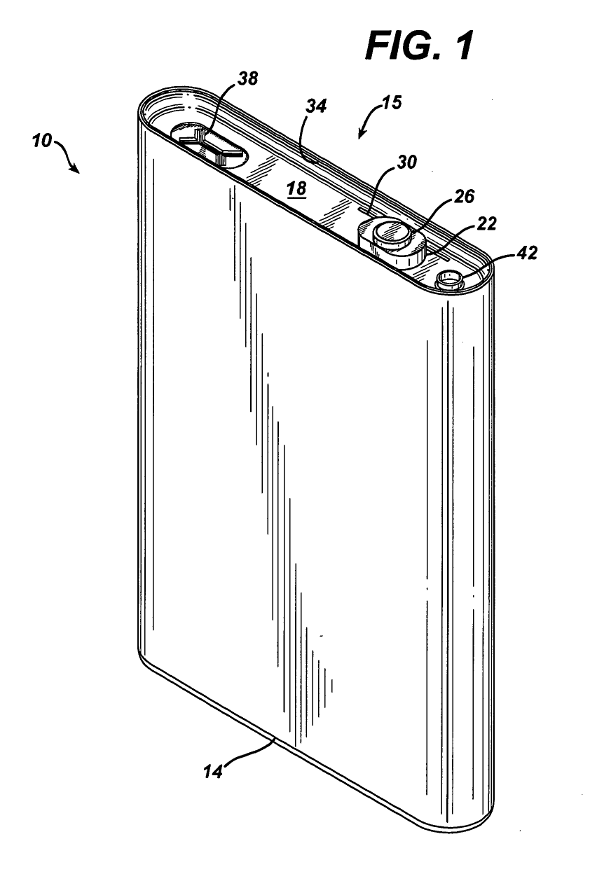

FIG. 1 shows a battery 10 having an open-ended housing 14 and a seal assembly 15 welded to the housing at its open end. Seal assembly 15 includes a metallic cover 18 having a polymeric rivet seal 22, a vent 38 that allows excessive gases generated in battery 10 to be relieved from the battery, and a fill hole 42 that allows the battery to be filled with electrolyte. Rivet seal 22 allows a rivet 26 (a metallic conductor such as aluminum, nickel or stainless steel) to pass through cover 18 while maintaining a liquid-tight seal between the rivet and the cover. Rivet 26, which serves as the positive electrode terminal of battery, extends from an exterior of battery to the interior of the battery where it contacts the cathode (not shown). Thus, rivet seal 22 also electrically isolates rivet 26 from cover 18, which contacts housing 14, which in turn contacts the anode (not shown) and serves as the negative electrode terminal.

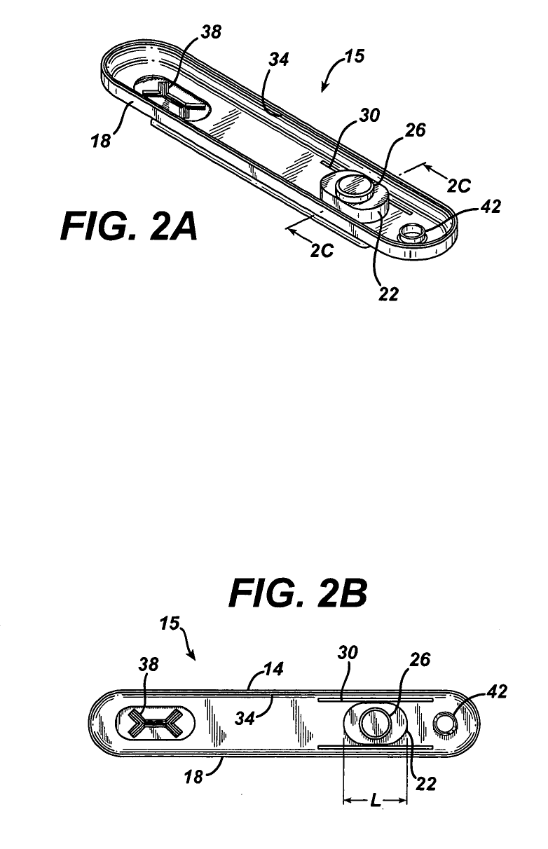

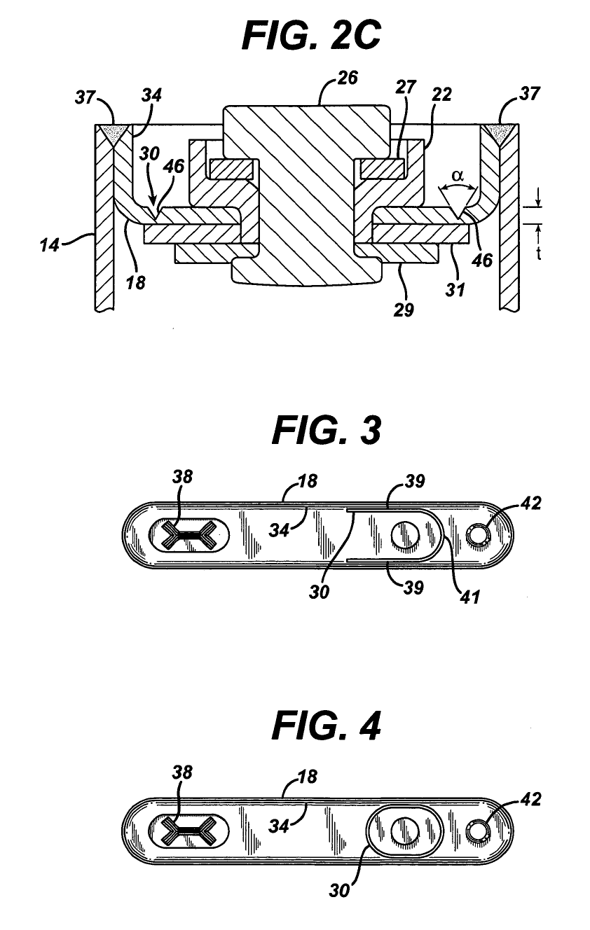

Referring also to FIGS. 2A, 2B, and 2C, seal assembly 15 further includes a support member 27 between rivet 26 and rivet seal 22, an insulator 31 next to cover 18, and a contact plate 29 contacting the rivet. Contact plate 29 (e.g., an elongated metallic plate) serves as a large area to which a current collector tab of a cathode (as shown) can be welded; as a result, rivet 26 can be electrically connected to the cathode. Insulator 31 (e.g., made of a fluoropolymer) electrically isolates the cathode from cover 18 and housing 14. As shown, support member 27 is an annular member used to transfer sealing forces to rivet seal 22 during assembly.

Still referring to FIGS. 2A, 2B, and 2C, cover 18 includes two parallel portions 30 with reduced thickness between an outer edge 34 of the cover and rivet seal 22. Because the rate of heat transfer is proportional to the cross-sectional area of the substance through which the heat is being transferred, portions 30 serve as heat chokes that limit heat transfer from outer edge 34 of cover 18 to rivet seal 22 when the cover is welded along its outer edge to a rim of housing 14. More specifically, since rivet seal 22 includes a polymer (such as polypropylene), the rivet seal can be sensitive to heat. But by limiting heat transfer from outer edge 34 of cover 18 to rivet seal 22, portions 30 reduce the likelihood that the rivet seal is exposed to sufficient heat to induce failure of the rivet seal. As shown, portions 30 are formed on cover 18 between rivet seal 22 and the portions of outer edge 34 that are the closest to the rivet seal because welding these portions of the outer edge exposes the rivet seal to the most heat. Referring to FIG. 2B, in some embodiments, portions 30 are formed on cover 18 between rivet seal 22 and portions of outer edge 34 that are up to about 2 L (e.g., less than about 1.5 L, less than about 1 L or less than about 0.5 L) from the closest point of the periphery of the rivet seal where L is the maximum width or diameter of the rivet seal. Portions 30 can be symmetrically or asymmetrically located relative to the rivet seal. Portions 30 can be formed anywhere between rivet seal 22 and the portions of outer edge 34 that are the closest to the rivet seal, including the area of the cover that would otherwise contact the rivet seal.

Other embodiments of portions 30 are possible. For example, referring to FIG. 3, cover 18 includes one portion 30 that includes two parallel and linear portions 39 of reduced thickness joined at their ends by a semicircular portion 41 of reduced thickness. Linear portions 39 and semicircular portion 41 are located between rivet seal 22 and portions of outer edge 34 that are closest to the rivet seal. In the embodiment shown in FIG. 4, portion 30 is configured as an racetrack shape portion of reduced thickness extending around rivet seal 22 in cover 18.

Portions 30 can be formed in a variety of cross sections. For example, FIG. 2C shows portions 30 having a triangular cross-section, but in other embodiments, portions 30 can be formed with other cross-sectional shapes, such as semicircular. For portions 30 with triangular cross sections, the angle defined by the side walls 46 can be about 30, 45, 60, 67, or 75 degrees. Expressed another way, the maximum depth of portions 30 can be greater than or equal to about 33 percent of the thickness t of cover 18, for example, greater than or equal to about 50, about 66, or about 75 percent of the thickness t of the cover.

Although portions 30 are shown on the top surface of cover 18, in some embodiments, portions 30 are formed on a bottom surface of the cover, alternatively or additionally to the portion(s) formed on the top surface.

Portions 30 can be made according to conventional production techniques. For example, portions 30 can stamped (e.g., with a die set) on cover 18 when the cover is made. Other methods include, for example, laser machining, coining, chemical etching, and milling. The methods may be performed during or after manufacture of cover 18.

Battery 10 can be made by placing an anode material, a cathode material, an electrolyte, and a separator into housing 14, and placing seal assembly 15 in the open end of the housing. Cover 18 can then be welded to housing 14 to seal battery 10.

While a number of embodiments have been described, the invention is not so limited. For example, in some embodiments, multiple heat chokes may be formed in the cover between a given edge of the cover and the seal.

In other embodiments, rivet 26 is hollow and can be used to fill battery 10 with electrolyte, rather than, for example, using fill hole 42.

Vent 38 provides a pressure relief mechanism that is closed under normal conditions but will open if the gasses produced within a battery exceed a predetermined pressure. As described above, battery 10 includes both vent 38 and portions 30, but in other embodiments (not shown), portions 30 can be configured to perform as a vent, i.e., to fail open when a predetermined internal pressure is exceeded.

Other embodiments are within the scope of the following claims.

What is claimed is:

1. A battery comprising:
a housing;
a cover having an outer edge, the cover connected to the housing at the outer edge; and
a seal engaged with the cover;
wherein the cover includes at least one portion of reduced thickness between the outer edge of the cover and the seal.

2. The battery of claim 1 wherein the portion of reduced thickness is a groove in the cover.

3. The battery of claim 2 wherein the groove has a triangular cross-section.

4. The battery of claim 2 wherein the groove has a semi-circular cross-section.

5. The battery of claim 1 wherein the portion of reduced thickness of the cover is between about 5 and about 90 percent of a thickness of the cover.

6. The battery of claim 5 wherein the portion of reduced thickness of the cover is between about 10 and about 50 percent of a thickness of the cover.

7. The battery of claim 1 wherein the portion of reduced thickness encircles the seal.

8. The battery of claim 1 wherein the cover defines two straight portions of reduced thickness located on opposing sides of the seal.

9. The battery of claim 8 wherein the cover further defines a semicircular portion of reduced thickness extending around a portion of the seal, the semicircular portion of reduced thickness connecting the two straight portions of reduced thickness.

10. The battery of claim 1 further comprising a conductor extending through the cover, the seal being between the conductor and the cover.

11. The battery of claim 10 wherein the conductor is a rivet.

12. The battery of claim 11 wherein the rivet defines an opening that extends through the rivet.

13. The battery of claim 1 wherein the portion of reduced thickness contacts the seal.

14. A battery comprising:
a housing;
a cover having an outer edge, the cover connected to the housing at the outer edge; and
a seal engaged with the cover;
wherein the cover includes two portions of reduced thickness between the outer edge of the cover and the seal, the portions of reduced thickness comprising two grooves in the cover located on opposing sides of the seal.

15. The battery of claim 14 wherein the groove has a triangular cross-section.

16. The battery of claim 14 wherein the groove has a semi-circular cross-section.

17. A method of manufacturing a battery comprising:
placing an anode material and a cathode material in a housing; and
welding a cover to the housing, the cover having a hole sized to receive a conductor, the cover including at least a portion of reduced cross-section between the outer edge of the cover and the hole.
